(19) United States
(12) Patent Application Publication
(10) Pub. No.: US 2016/0050069 A1
(43) Pub. Date: Feb. 18, 2016

(54) METHOD AND SYSTEM FOR MEDIA PATH SECURITY

(71) Applicants: Nick PELIS, San Francisco, CA (US); Jonathan EMMETT, Bellevue, WA (US); IRDETO B.V., Hoofddorp (NL)

(72) Inventors: Andy Griffin, San Francisco, CA (US); Nick Pelis, San Francisco, CA (US); Jonathan Emmett, Bellevue, WA (US); Dan Murdock, Waterloo (CA); Phil Eisen, Ottawa (CA); James Muir, Kanata (CA); Jianping Wu, Ottawa (CA); Clifford Liem, Ottawa (CA)

(21) Appl. No.: 14/780,118

(22) PCT Filed: Mar. 28, 2013
(86) PCT No.: PCT/US13/34444

§ 371 Date: Sep. 25, 2015

(51) Int. Cl. H04L 9/32; G06F 21/60

(52) U.S. Cl. CPC H04L 9/321; G06F 21/602; H04L 2209/24

(57) ABSTRACT

The present disclosure provides a system for media path security includes an authoring system having a content stream transform and corrupter for corrupting content data and providing decorrupting data, a media container for conveying the corrupted content data and decorrupting data, and a client system having a fix-up component for fixing the corrupted content data in dependence upon the decorrupting data. A client system is also provided as having an input for receiving a media container and a fix-up component for fixing the corrupted content data in dependence upon the decorrupting data.

### FIELD OF THE INVENTION

The present invention relates to methods and systems for media path security and is particularly concerned with securing digital media.

### BACKGROUND OF THE INVENTION

Many media playback devices offer a protected media path to ensure that during playback, audiovisual content cannot be extracted from said device. They all suffer from the problem that the interface to them is in user-accessible memory. As such, content that moves from one domain of protection into the media path protection domain must be exposed to user-space attacks.

Systems and methods disclosed herein provide method and system for media path security to obviate or mitigate at least some of the aforementioned disadvantages.

### SUMMARY OF THE INVENTION

An object of the present invention is to provide an improved method and system for media path security.

The present disclosure provides an extension of security control that is associated with digital content that is distributed on an optical disk, on USB drive, on a hard drive, on a solid-state disk (SSD), or in a file or directory over a connected network. This extension of control to existing systems provides a point at which transformed (i.e. corrupted) video data may either be fixed-up and encrypted for the GPU (Graphics Processing Unit), or fixed up and recorrupted for processing and further fix up by a software decoder, or fixed up and decompressed for subsequent software decoding. Each of the fix-up and encryption process, or fix up and recorruption process, or fixup/decompression process are blended as a single operation and protected in a manner resistant to white-box attacks. The fix-up/encryption, fixup/decompression, or fix-up/recorruption operation is diverse per content and is associated and distributed together with the content. The player invokes the fix-up/encryption, or fix-up/recorruption, or fixup/decompression operation given the appropriate signalling from the code distributed with the content. The encryption protection of the video data (through encryption, further corruption, or decompression is uniquely provided to either the GPU or software decoder of the video rendering sub-system and is therefore not easily cloned or siphoned when under attack.

The present invention describes a method and system for media path protection from authoring to deployment to many consumers.

In accordance with one aspect of the present disclosure there is provide a system for media path security comprising an authoring system having a content stream transform and corrupter for corrupting content data and providing decorrupting data, a media container for conveying the corrupted content data and decorrupting data, and a client system having a fix-up component for fixing the corrupted content data in dependence upon the decorrupting data.

In accordance with another aspect of the present disclosure there is provided a method of providing media path security, the method comprising, in an authoring system, authoring content data, corrupting and transforming the authored content data to provide corrupted content data and decorrupting data, storing the corrupted content data and the decorrupting data in a media container, conveying the media container to a client system, in the client system, fixing the corrupted content data in dependence upon the decorrupting data.

In accordance with another aspect of the present disclosure there is provided a client system comprising an input for receiving a media container and a fix-up component for fixing the corrupted content data in dependence upon the decorrupting data.

### BRIEF DESCRIPTION OF THE DRAWINGS

The present invention will be further understood from the following detailed description with reference to the drawings in which:

FIG. 1 illustrates a system overview in accordance with an embodiment of the disclosure;

FIG. 2 illustrates a client system overview in accordance with an embodiment of the disclosure;

FIG. 3 illustrates authoring-side media preparation in accordance with an embodiment of the present disclosure;

FIG. 4 illustrates client-side media processing in the client system in accordance with another embodiment of the present disclosure; and

FIG. 5 illustrates client-side media processing in the client system in accordance with a further embodiment of the present disclosure.

FIG. 6 illustrates client-side media processing in the client system in accordance with a further embodiment of the present disclosure.

### DETAILED DESCRIPTION OF THE PREFERRED EMBODIMENT

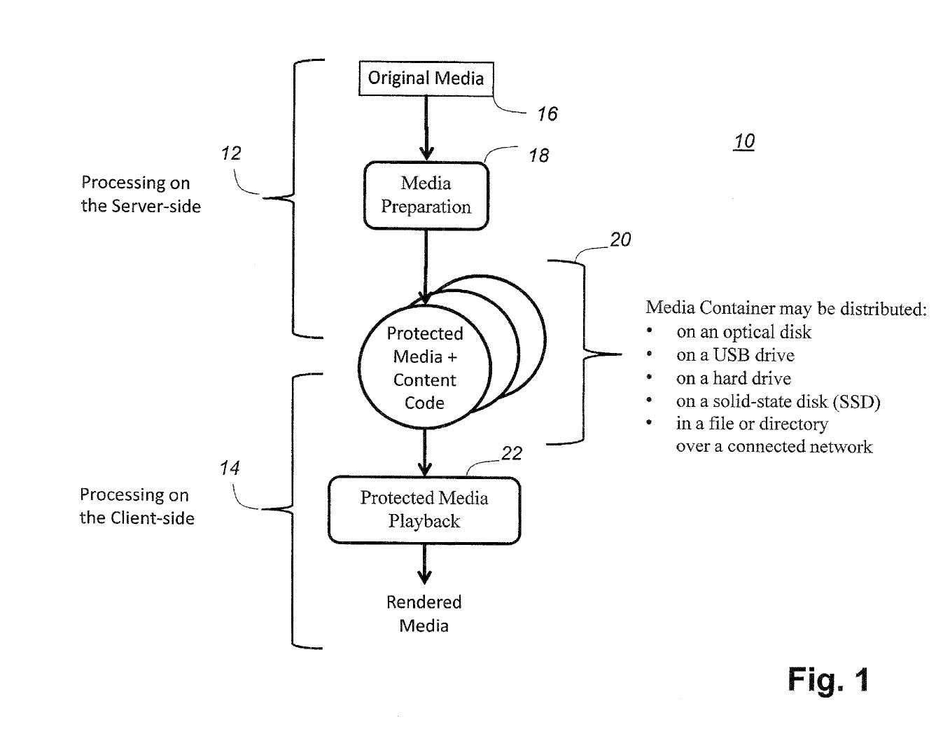

Referring to FIG. 1 there is illustrated a system overview in accordance with an embodiment of the disclosure. There are two main parts to the system and method 10, authoring-side processing 12 and client side processing 14.

Authoring-side Processing. Taking the original unprotected media 16 as input, the first step involves preparing 18 the media in a protected, transformed form. Then the protected media together with content code is released in a media container 20. The media container 20 may be distributed in many forms. These include, but are not limited to: on an optical disk, on a USB drive, on a hard drive, on a solid-state disk (SSD), in a file or directory over a connected network.

Client-side Processing. The client-side media player then takes a media container 20 and performs protected media playback 22 on the media. The player performs demultiplexing of the stream and relegates processing of the elementary video stream to the native content code. The native content code is provided with the protected media in the media container.

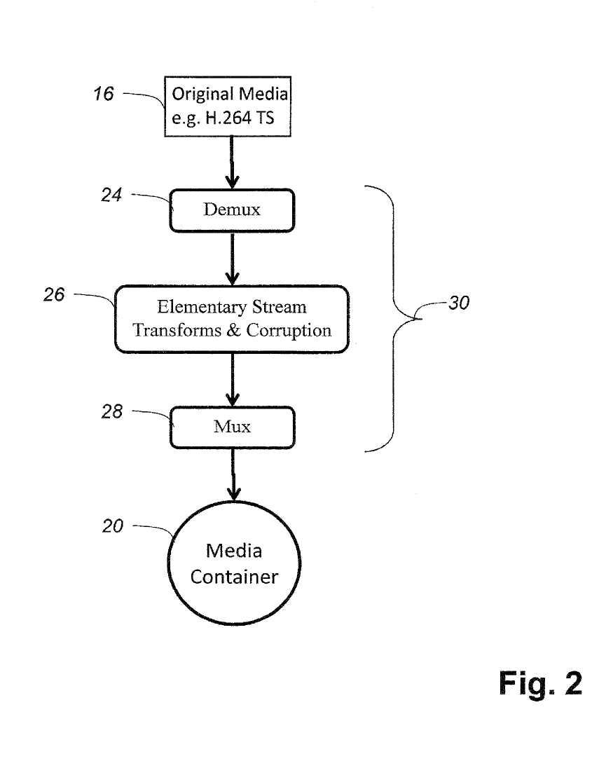

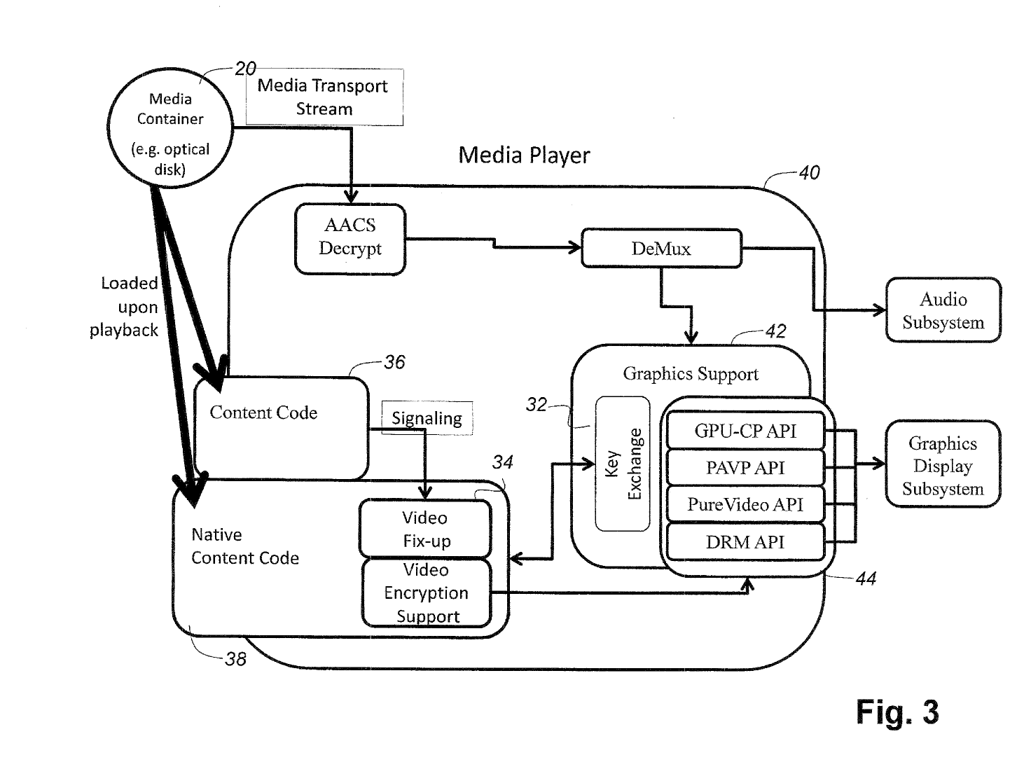

Referring to FIGS. 2 and 3, the currently described system contains three major components, a media transform component 30, a key exchange component 32 and fix-up component 34.

The media transform component 30 includes a demux 24, an elementary stream transform and corruptor 26 and a mux 28.

In operation, the media transform component 30 after demuxing, transforms the original encoded media 16 (e.g. H.264, MPEG, VC-1) by uniquely identifying parts of the elementary stream, corrupting essential data, encoding said data in tables and the stream itself, and providing configuration data to a build system for the second component, the key exchange component 32.

The media transform component 30 is a build-time only component, is never distributed and is used only in preparation of protected media and associated code/data. The media transform component 30 is used on the head-end/authoring side 12 of the system 10. After the media stream is demultiplexed 24, the video is corrupted 26 by removing blocks of the stream and replacing said blocks with random data. The video data that is removed from the stream is transformed and placed in a data table. The corruption is localized based upon the Presentation Time Stamp, which is used to achieve synchronization of separate elementary streams (e.g. video, audio, subtitles).

The media transform (MT) process is set-up to work together with AES encryption. The locations where corruption can take place are restricted, based upon how the compressed stream will ultimately be blocked and encrypted for a graphics card. Once the location of the corrupted bytes has been determined, a transformation is chosen that is placed on the uncorrupted bytes as stored in an external table. Data transformations are produced according to U.S. Pat. No. 6,594,761, U.S. Pat. No. 6,842,862, and U.S. Pat. No. 7,350,085.

In MPEG and H.264 video encoding, the timing and navigational information are relative to both the offset within a clip (M2TS file) and the Presentation Time Stamp (in the M2TS PES-packet header). Post-demux neither of these are available, and there is no uniquely identifying information in the H.264 data to say to which Presentation Time or clip offset any particular H.264 element belongs and therefore to workout where to apply fix-ups. Within the frame header there are “Frame Number” and “Picture Order Count” fields, but these are not unique, absolute or monotonically increasing values within the H.264 stream.

Depending on what constitutes the output of the demultiplexer 24, the process may or may not have access to complete and/or aligned H.264 Nal Units. The process may be only have slice or frame data or may be passed data corresponding to non-frame H.264 Nal units. The process may have a complete frame or a single slice. Hence a broad problem for applying fix-ups post-demultiplex is identification, that is deciding which frame is currently being processed in the demultiplexed stream and synchronization, that is finding a reference point from which to analyze the data.

In most demultiplexers surveyed, blocking by multiple Nal units was observed. Some demultiplexers presented all H.264 Nal units, some just those Nal units relating to frame data. Some included MPEG start codes, whereas some replaced start codes with length fields. In the worst case and in a pure M2TS stripper one may just have a byte stream.

For the case requiring the handling of synchronization and frame identification from an H.264 byte stream, the present solution is to analyze the post-demultiplex byte stream constantly monitoring for the presence of MPEG start codes. Each time a start code is observed this was treated a base indexing point and counting bytes was started. Also at this point the process would initialize the calculation of a 64 bit hash. For fix-ups, the process is interested in affecting frame data, especially for option three where frame data is the only thing that the process is allowed to corrupt. Within an H.264 slice header there are various fields that are broadly similar between frames, and broadly constant across all slices within the same frame. The process needs to ensure that a hash is calculated sufficiently past the end of the slice header to be certain that video data is being hashed. Furthermore, whilst these values are non-unique across the whole clip, by including the Frame Number and Picture Order Count fields from the slice header within the hash calculation the process is also able to discriminate between different frames that have similar video data. After testing, it was found that good results were achieved using a CRC-64 over the first 64 bytes of frame data. As frames can easily span over 1000 packets and clearly it is undesirable to hash the full frame for performance reasons. A hash of 64 bytes was found to give good discrimination.

In this way, the process can specify fix-ups as a combination of a hash, a byte offset from the MPEG start code and a 5-byte overwrite. This was shown experimentally to provide uniqueness in a representative movie clip, and also in cases where hashes are not unique, uniqueness can be enforces at MT-time by only locating fix-ups in frames with unique hash values.

The key exchange component 32 is associated with a player 40. The player 40 loads the content code 36 and native content code 38, which negotiates a session key with a graphic processing unit (GPU) 42, uniquely protects this key and shares this key with the third component, the fix-up component 34.

Key exchange component a Key-Exchange Library. The key exchange component 32 is associated with each player 40, is unique per player and is parameterized based upon data provided together with the content. The key exchange component 34 contains library functions for the secure establishment of keys for the encryption of video data to the graphics processing unit (i.e. GPU) endpoint. The key-exchange library 44 supports four different GPU key-exchange protocols: GPU-CP, AMD/ATI UVD (Unified Video Decoder), Nvidia VP2, and Intel PAVP. Although the protocols may differ, the general solution is the same for each media path. The intent is to provide a secure path for encrypted video to be sent to the GPU endpoint. Each of the key-exchange protocols has different steps to produce a secure encryption-key, but each arrives at the same conclusion, a secured key for encryption to the GPU. The support for all four protocols gives the solution the broadest range of support over operating system variations (i.e. Win8, Win7, Vista, WinXP) and GPU vendor variations (Nvidia, AMD/ATI, Intel). Note that the solution is not limited to these systems and GPUs, but is easily extended to other operating systems and GPUs, supporting a key-exchange protocol and hardware-based decryption.

The key exchange library 44 is an encapsulation of the OS and GPU-specific protocol needed to establish an AES symmetric key that can be used to encrypt the video stream. The AES key is established together with data transformations (U.S. Pat. No. 6,594,761) protecting the key, destined for a WhiteBox implementation of the AES encryption routine (described in U.S. Pat. No. 7,464,269, U.S. Pat. No. 7,971,064). Information is securely passed between the key-exchange library and the WhiteBox AES implementation, in a manner that never reveals the key, neither statically nor dynamically. Furthermore, the video data that is encrypted may also contain certain corruptions which are corrected, as described in the next section,

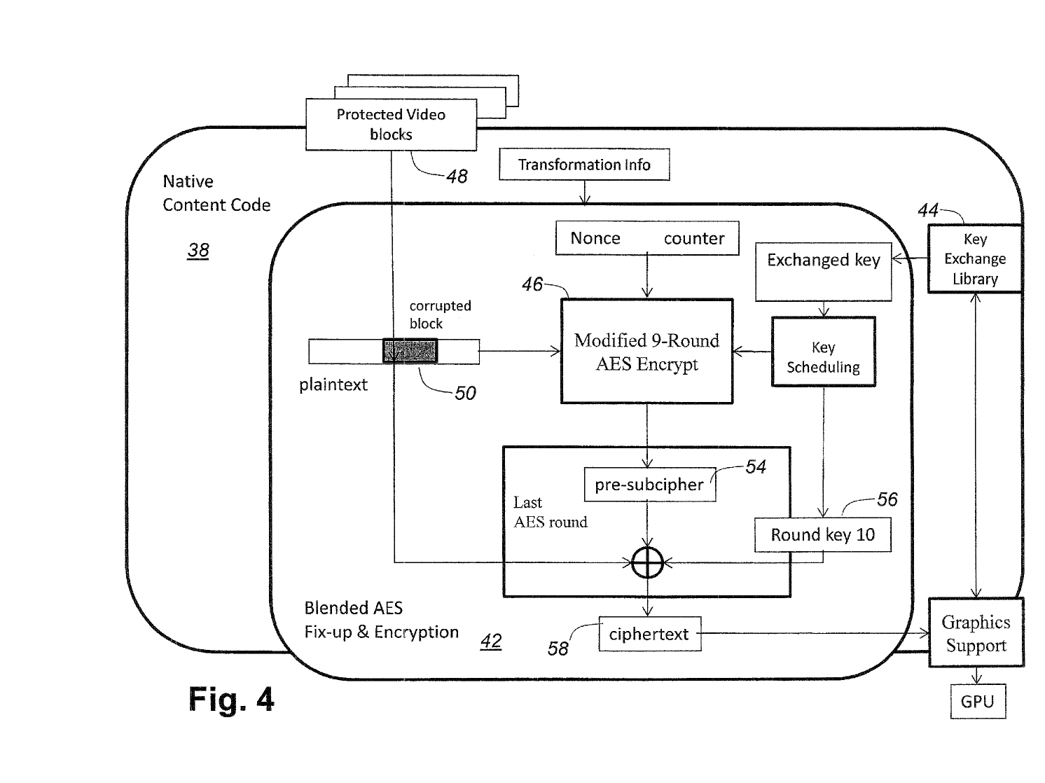

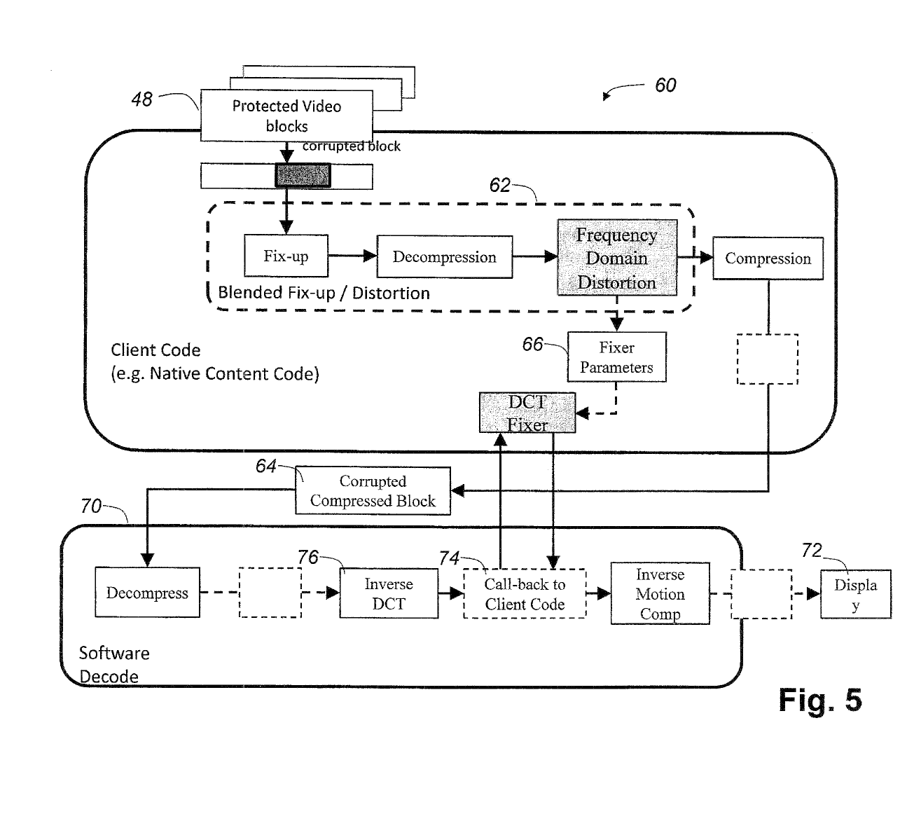

Referring to FIGS. 4 and 5 there are illustrated client-side media processing of the forms fix-up component. The fix-up component 34 can be in one of two forms, depending upon the environment in which it is running.

In FIG. 4, there is illustrated a first form 42 of the fix-up component 34. The fix-up form 42, upon invocation, uniquely fixes-up the stream, while blending this operation into the first rounds of an AES (Advanced Encryption Standard) encryption 46 destined for the GPU. The key of the AES operation is never revealed at any point during operation.

In FIG. 5, there is illustrated a second form 60 of the fix-up component 34. The fix-up form 60, upon invocation uniquely fixes-up the stream, while blending this operation into a recorruption operation 62 in order to protect the video data throughout its processing in the frequency domain, as per [WO2013/033807 International Patent Application, Andrew Szczeszynski et al.].

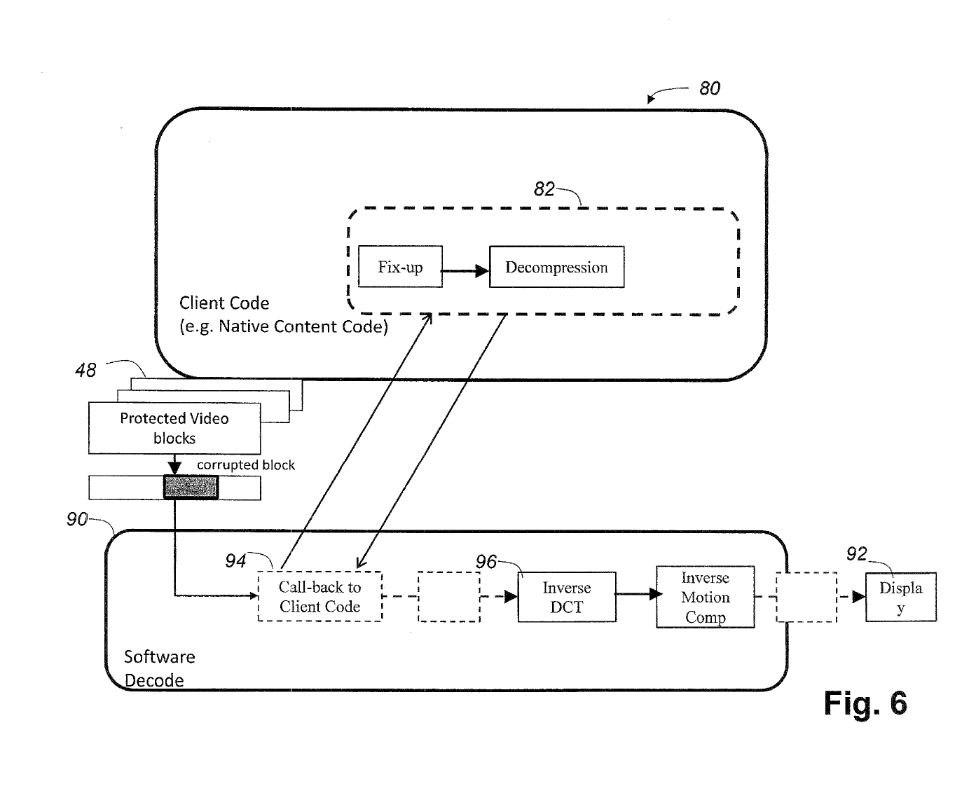

In FIG. 6, there is illustrated a third form ## of the fix-up component 34. The fix-up form ##, upon invocation uniquely fixes-up the stream, while blending this operation into a variable-length decoding operation ## in order to protect the video data throughout its processing in the compressed domain, as per [WO2013/033807 International Patent Application, Andrew Szczeszynski et al.].

### The First Form of the Fix-Up Component—White-Box AES/Fix-Up Blending

The first form 42 of the fix-up component 34 is uniquely prepared per content 36 and is distributed together with the content. The native content code 38 is loaded by the media player 40 to uniquely playback the media content.

As the player 40 encounters a container 20 with the blending feature available. the player 40 first loads the content code 36 associated with the container 20 during initialization. Then, the key exchange component 32 negotiates a key for encryption. This key, along with configuration parameters for the encryption type, are then passed from the key exchange component 32 to fix-up component 42, in a protected fashion. Finally, the native content code 38 of the fix-up component 42 performs a blended White-Box AES encryption and fix-up of the video data destined directly for the GPU.

The details of the AES encryption are depicted in FIG. 4, where the native content code 38 does a full blended encryption for the endpoint GPU. Protected video blocks 48 enter into the content code, along with data describing the transformations. Transformed plaintext 50 is passed to the AES implementation 46, along with a corrupted block, which adheres to the set of alignment constraints described earlier. These constraints provide a framework that allows efficient processing within the AES implementation.

For the transformed case, the process performs operations that compute an xor 52 on bytes of the pre-subcipher 54, round key 56 and transformed plaintext 50, where the plaintext has a 40-bit Mixed Boolean Arithmetic Transform (described further in Yongxin Zhou, Alec Main, Yuan Xiang Gu, Harold Johnson: “Information Hiding in Software with Mixed Boolean-Arithmetic Transforms”, Lecture in Computer Science Volume 4867, 2007, pp 61-75).The other inputs may or may not be transformed; however, the output is untransformed. This is done to ensure playback on the GPU endpoint.

A transformed 40-bit xor collection of operations performs the necessary computations on the pre-subcipher and round key using a byte-wise to word-wise conversion in the last round of key scheduling and similar conversions after the final SubBytes step in the AES algorithm.

For the other bytes in the calculation, the plaintext for these bytes is untransformed, but the pre-subcipher and round key may both be transformed. There are two groups of bytes which can be handled by collections of operations of the appropriate size. This means there are two other byte-wise to word-wise transforms for the last round of key scheduling and final SubBytes step. A single collection of operations is created that handles the entire block, by including coefficients that describe the breakdown of the groups within that block. The untransformed case is not that different from the transformed case, because even in the transformed case, most of the plaintext bytes are untransformed.

The key and initialization vector are both transformed in a standard fashion. In AES CTR mode encryption, the plaintext is only used at the very last step, where it is xor'ed with the subcipher derived by encrypting the counter. Thus, for the current case, almost the entire WBAES implementation is identical to one of the Applicant's existing dynamic-key implementations, since both size and performance are important considerations.

The implementation after the final SubBytes step, is split when there is a pre-subcipher. At this point, the remaining steps are:

1. Final AddRoundKey to produce subcipher.

2. Xor subcipher with plaintext to produce the ciphertext 58.

### The Second Form of the Fix-Up Component—Runtime Distortion/Fix-Up Blending

The second form 60 of fix-up component 34 is shown in FIG. 5. In the second form 60, includes a blended with a runtime distortion operation 62, instead of an encryption operation. This is a case that supports the video decode operation performed in software, instead of directly on a GPU. An advantage to this approach is that the present system is more generally applicable to different playback systems. However, the CPU of the system must meet the performance required by the video bitrate.

A runtime distortion operation 62 is defined as the insertion of a frequency domain distortion and a corresponding spatial domain fixer as described in detail in [WO2013/033807 International Patent Application, Andrew Szczeszynski et al.].

The distortion of the video content 48 takes place in client code in general. This can be either part of the player or loaded dynamically with the content. An example of dynamically loaded client code is the native content code, that is the component associated and distributed with the content. The dynamically loaded native content code is the best mode as it provides the security capabilities of renewable protection mechanisms and diversity. Diversity means that the native content can be made different per distributed content, making differential attacks more difficult.

The frequency domain distortion and produces two outputs:

1. the distorted video content 64, and

2. a set of ‘fixer’ parameter data 66 that may be used to repair the content.

The distorted video content 64 is passed through the normal video processing path 70, destined for a display 72. However, untreated, this video is corrupted and not useful for the consumer. The repair of the content occurs as a call-back 74 into the client code from the software decode stage after an inverse frequency transformation step 76. For example, the inverse frequency transformation may be an Inverse Discrete Cosine Transform, IDCT. This repair of the video occurs in the spatial domain, providing a lossless fix-up of the video data. The video data then continues along the normal video processing path to the display 72.

In the case of runtime distortion, the original corrupted block fix-up of the video is blended with the frequency domain distortion of the video. This can be done in a number of ways:

1) Data transforms as described in U.S. Pat. No. 6,594,761, U.S. Pat. No. 6,842,862, and U.S. Pat. No. 7,350,085 may be used at each of the data passing steps (i.e. from the input to fix-up, from fix-up to decompression, and from decompression to frequency domain distortion)

2) Fix-up is combined with decompression (e.g. CABAC decoding) in one operation.

3) Decompression is combined with frequency domain distortion in one operation.

4) Fix-up, decompression for example CABAC decoding, and frequency domain distortion are combined in one operation.

Any combination of the above techniques may be used to protect against an attack of the video stream at a point after the fix-up, the last of which is the best mode. Furthermore, the ‘fixer’ parameters, being a set of meta-data, which directs how the stream must be fixed-up in the spatial domain, must also be protected. This data can also be protected with data transforms (as described in U.S. Pat. No. 6,594,761, U.S. Pat. No. 6,842,862, and U.S. Pat. No. 7,350,085). Moreover, these transformations may be ‘aggressive’, as this path is not performance-sensitive when compared with the video path.

The runtime distortion case may be applied to any spatial domain transformation. For example, a discrete wavelet transform (DWT) provides a time-frequency representation of image, video, or audio. The distortion case may equally be applied to the wavelet representation and subsequently fixed-up in the spatial domain, analogously to the frequency domain case.

### The Third Form of the Fix-Up Component—Runtime Fix-Up/CABAC Decode Blending

The third form 80 of fix-up component is shown in FIG. 6. The third form 80 includes a fixup operation with a variable length decode operation 82, instead of an encryption or distortion operation. This is a case that also supports the video decode operation performed in software instead of directly on a GPU, but requires less complex software decode integration. An advantage to this approach is that the present system is both more generally applicable to different playback systems, but is less secure than either of the other two systems. The CPU of the system must also meet the performance required by the video bitrate.

The decompressed (CABAC or CAVLC, for example) video content is passed through the normal video processing path 90, destined for a display 92, without the original compressed video being exposed to attackers.

In the case of fixup & decompression blending, the original corrupted block fix-up of the video is blended with the protected decompression of the video with data transforms as described in U.S. Pat. No. 6,594,761, U.S. Pat. No. 6,842,862, and U.S. Pat. No. 7,350,085 may be used at each of the data passing steps (i.e. from the input to fix-up, from fix-up to decompression, and from decompression to frequency domain distortion)

The fixup and decompression blending can be applied to many different kinds of video compression. CABAC and CAVLC both supported by the H.264 video encoding specification, but other compression in other video encodings can also be supported,

Numerous modifications, variations and adaptations may be made to the particular embodiments described above without departing from the scope patent disclosure, which is defined in the claims.

What is claimed is:

1. A system for media path security comprising:
an authoring system having a content stream transform and corrupter for corrupting content data and providing decorrupting data;
a media container for conveying the corrupted content data and decorrupting data; and
a client system having a fix-up component for fixing the corrupted content data in dependence upon the decorrupting data.

2. The system of claim 1, wherein the media container includes native content code and the client system includes a processor for running the native content code for invoking a key exchange between the fix-up component and an encryption key exchange component.

3. The system of claim 2, wherein the key exchange component accesses a key exchange library.

4. The system of claim 3, wherein the key exchange library provides support for a plurality of graphic processing unit protocols.

5. The system of claim 1, wherein the media container includes native content code and the client system includes a processor for running the native content code for invoking a blended fix-up and distortion process.

6. The system of claim 5, wherein the blended fix-up and distortion process outputs a corrupted or encrypted compressed block of data.

7. The system of claim 6, wherein the blended fixup and variable-length decoding process outputs a decompress elementary stream to the software decoder for display.

8. The system of claim 1, wherein the media container includes virtualized content code and the client system includes a processor for running the virtualized content code for invoking a key exchange between the fix-up component and an encryption key exchange component.

9. The system of claim 8, wherein the key exchange component accesses a key exchange library.

10. The system of claim 9 wherein the key exchange library provides support for a plurality of graphic processing unit protocols.

11. The system of claim 1, wherein the media container includes virtualized content code and the client system includes a processor for running the virtualized content code for invoking a blended fix-up and distortion process.

12. The system of claim 11, wherein the blended fix-up and distortion process outputs a corrupted or encrypted compressed block of data.

13. The system of claim 12, wherein the blended fixup and variable-length decoding process outputs a decompressed elementary stream to the software decoder for display.

14. The system of claim 6, wherein the client system includes a decode process for rendering the corrupted compressed block of data to a display.

15. A method of providing media path security, the method comprising:
in an authoring system, authoring content data;
corrupting and transforming the authored content data to provide corrupted content data and decorrupting data;
storing the corrupted content data and the decorrupting data in a media container;
conveying the media container to a client system;
in the client system, fixing the corrupted content data in dependence upon the decorrupting data.

16. The method of claim 15, wherein the step of fixing includes exchanging an encryption key.

17. The method of claim 16, wherein the step of fixing includes blending encryption using the encryption key and fixing the data corruption.

18. The method of claim 15, wherein the step of fixing up the corrupted content data includes blending fix-up and then distorting the fixed data to produce a corrupted compressed block of data.

19. The method of claim 18 further comprising the step of a decoding the corrupted compressed block of data for rendering to a display.

20. A client system comprising:
an input for receiving a media container; and
a fix-up component for fixing the corrupted content data in dependence upon the decorrupting data.

21. The client system of claim 20, wherein the media container includes native content code and the client system includes a processor for running the native content code for invoking a key exchange between the fix-up component and an encryption key exchange component.

22. The system of claim 21, wherein the key exchange component accesses a key exchange library.

23. The system of claim 22, wherein the key exchange library provides support for a plurality of graphic processing unit protocols.

24. The system of claim 20, wherein the media container includes native content code and the client system includes a processor for running the native content code for invoking a blended fix-up and distortion process.

25. The system of claim 24, wherein the blended fix-up and distortion process outputs a corrupted compressed block of data.

26. The system of claim 25, wherein the client system includes a decode process for rendering the corrupted compressed block of data to a display.
